(19) United States
(12) Patent Application Publication
(10) Pub. No.: US 2008/0024064 A1
(43) Pub. Date: Jan. 31, 2008

(54) Plasma display panel (PDP)

(76) Inventors: Tae-Woo Kim, Suwon-si (KR); Sang-Hoon Yim, Suwon-si (KR)

Correspondence Address: Robert E. Bushnell, Suite 300, 1522 K Street, N.W., Washington, DC, 20005, US

(21) Appl. No.: 11/878,267

(22) Filed: Jul. 23, 2007

(30) Foreign Application Priority Data
Jul. 31, 2006 (KR) 10-2006-0072070

(51) Int. Cl. H01J 17/49

(52) U.S. Cl. 313/585

(57) ABSTRACT

A Plasma Display Panel (PDP) having improved transformation efficiency includes: a first substrate, a second substrate facing the first substrate, discharge cells partitioned between the first substrate and the second substrate, first electrodes extending in a first direction between the first substrate and the second substrate, second electrodes extending in a second direction crossing the first direction between the first substrate and the second substrate and protruding in a direction away from the second substrate, third electrodes extending in the second direction between the first substrate and the second substrate and protruding in a direction away from the second substrate, and phosphor layers arranged within the discharge cells, the discharge cells including a first portion having the second and third electrodes arranged therein and a second portion devoid of second and third electrodes therein. A phosphor layer formed within the second portion has a height, measured in a direction perpendicular to the first substrate, greater than a distance between the first substrate and the second and third electrodes.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 315′ of July 2006 and there duly assigned Serial No. 10-2006-0072070.

### BACKGROUND OF THE INVENTION

1. Field of the Invention

The present invention relates to Plasma Display Panel (PDP), and more particularly, the present invention relates to a PDP having improved visible light transformation efficiency.

2. Description of the Related Art

Plasma Display Panels (PDPs) display an image by using visible light generated when vacuum ultraviolet rays (VUVS) radiating from a plasma generated by a gas discharge excite a phosphor material. The PDPs enable extra-large size screens of greater than 60 inches to be thinner than 10 cm. In addition, the PDPs have excellent capacity for reproducing colors and no distortion according to viewing angle. The PDPs have advantages of greater productivity and lower cost due to a simpler method of manufacturing than Liquid Crystal Displays (LCDs), and are spotlighted as the next generation industrial flat panel display and home TV display.

The structure of the PDP has been developed and improved for many years, since the 1970s, and the generally-known structure now is a three-electrode surface discharge PDP. The three-electrode surface discharge PDP includes one substrate having two electrodes arranged on the same surface, and another substrate arranged at a certain distance therefrom and including address electrodes extending in a perpendicular direction. A discharge gas is filled within the space between the pair of substrates and the substrates are sealed together.

Generally, whether or not a discharge occurs is determined by the discharge of scan electrodes that are connected to each line and independently controlled, and address electrodes facing the scan electrodes. In addition, a sustain discharge that displays brightness is generated by two electrode groups, namely sustain electrodes and scan electrodes, that are located on the same surface.

However, the three-electrode type of surface discharge PDPs have a problem in that the discharge efficiency decreases because the gap between address electrodes and scan electrodes is narrow. That is, a cathode sheath around the cathode, an anode sheath around the anode, and a positive column between the two sheaths are formed during a sustain discharge, and the positive column related to discharge efficiency is formed to be short in the three-electrode type of surface discharge PDP.

Therefore, in order to solve this problem, a PDP with an opposed discharge structure of opposed discharge and that is capable of forming a longer positive column has been provided. In this structure, however, a space where a discharge between a sustain electrode and a scan electrode occurs is located at a certain distance from a space where visible light is generated by a phosphor layer along a direction perpendicular to a substrate. In other words, although the transformation efficiency of ultraviolet light rays into visible light needs to be high in order to generate visible light of a high brightness, a phosphor layer is located at a certain distance from a space where a discharge occurs in this structure, and accordingly, there is a problem in that the transformation efficiency of visible light is not sufficient.

### SUMMARY OF THE INVENTION

The embodiments of the present invention provide a Plasma Display Panel (PDP) having improved visible light transformation efficiency by arranging a phosphor layer close to a discharge space.

According to one aspect of the present invention, a Plasma Display Panel (PDP) is provided having a first substrate, a second substrate facing the first substrate, discharge cells partitioned between the first substrate and the second substrate, first electrodes extending in a first direction between the first substrate and the second substrate, second electrodes extending in a second direction crossing the first direction between the first substrate and the second substrate and protruding in a direction away from the second substrate, third electrodes extending in the second direction between the first substrate and the second substrate and protruding in a direction away from the second substrate, and phosphor layers arranged within the discharge cells. The discharge cells include a first portion where the second electrodes and the third electrodes are arranged, and a second portion devoid of the second and third electrodes. A phosphor layer formed within the second portion has a height, measured in a direction perpendicular to the first substrate, greater than a distance between the first substrate and the second and third electrodes.

The PDP may further include barrier ribs partitioning the discharge cells and arranged adjacent to the first substrate, the barrier ribs including first barrier rib members extending along the first direction and second barrier rib members extending along the second direction.

The PDP may further include second barrier ribs partitioning the discharge cells and arranged adjacent to the second substrate, the second barrier ribs including third barrier rib members extending along the first direction and fourth barrier rib members extending along the second direction.

A first discharge space may be defined by the first barrier rib members and the second barrier rib members, a second discharge space facing the first discharge space may be defined by the third barrier rib members and the fourth barrier rib members, and each discharge cell may be partitioned by the first discharge space and the second discharge space.

Electrode dielectric layers may be arranged on outer surfaces of the second electrodes and the third electrodes, the electrode dielectric layers may include first dielectric members extending along the first direction and second dielectric members crossing the first dielectric members and extending along the second direction.

The first dielectric members may be arranged to correspond to the first barrier rib members, and the phosphor layers may be arranged on sides of the first dielectric members and the first barrier rib members.

The second electrodes and the third electrodes may be arranged on the boundary of discharge cells adjacent to each other along the first direction, and arranged alternately along the first direction.

The first electrodes may be arranged on the boundary of discharge cells adjacent to each other along the second direction on the second substrate, and include expansion electrodes protruding into centers of respective discharge cells.

The expansion electrodes may be arranged closer to the third electrodes than the second electrodes.

According to another aspect of the present invention, a plasma display panel is provided having expanded portions arranged to correspond to respective discharge cells and extending from the first barrier rib members in a direction perpendicular to the first substrate, and phosphor layers arranged on the expanded portions.

The expanded portions and the first barrier rib members may have a unitary structure, recessed portions may be arranged between expanded portions adjacent to each other along the first direction, and the recessed portions may be arranged on boundaries of discharge cells adjacent to each other along the first direction.

The second electrodes and the third electrodes may be arranged in the recessed portions, and a height of the phosphor layers, measured along a direction perpendicular to the first substrate, may be greater than a distance between the first substrate and the second and the third electrodes.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of a Plasma Display Panel (PDP) according to a first embodiment of the present invention.

FIG. 2 is a partial plan view of the structure of electrodes and discharge cells in the PDP according to the first embodiment of the present invention.

FIG. 3 is a cross-sectional view of the PDP taken along the line III-III in FIG. 1.

FIG. 4 is a cross-sectional view of the PDP taken along the line IV-IV in FIG. 1.

FIG. 5 is a partial exploded perspective view of a PDP according to a second embodiment of the present invention.

FIG. 6 is a partial exploded perspective view of a PDP according to a third embodiment of the present invention.

### DETAILED DESCRIPTION OF THE INVENTION

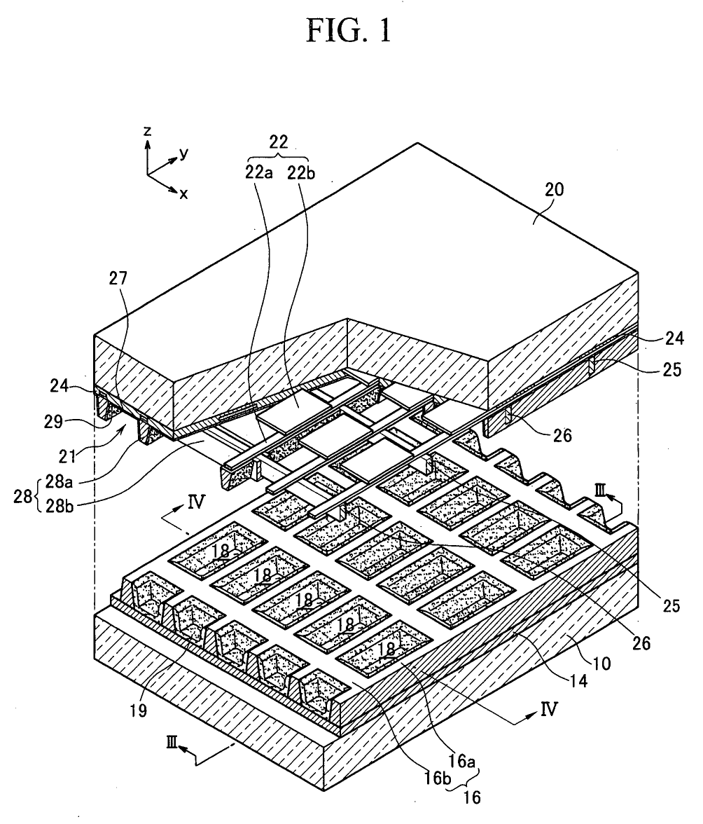

Referring to FIG. 1, a Plasma Display Panel (PDP) of the first embodiment of the present invention includes a first substrate (hereinafter referred to as a rear substrate) and a second substrate (hereinafter referred to as a front substrate) facing each other with a certain distance therebetween. A plurality of discharge spaces 18 and 21 are partitioned between the rear substrate 10 and the front substrate 20. Phosphor layers 19 are formed within the discharge spaces 18 and 21, and they absorb ultraviolet rays and radiate visible light. The discharge spaces 18 and 21 are filled with a discharge gas (for example, a gas mixture including xenon (Xe), neon (Ne), etc.).

A first dielectric layer (hereinafter referred to as a rear dielectric layer) is formed on the surface of the rear substrate 10 facing the front substrate 20. First barrier ribs 16 are formed on the rear dielectric layer 14 and partition the plurality of discharge spaces 18. Although the first barrier ribs 16 are formed on the rear dielectric layer 14 in the present embodiment, the first barrier ribs 16 can be formed directly on the rear substrate 10 without forming the rear dielectric layer 14 thereon. In addition, the first barrier ribs 16 may be formed through etching the rear substrate 10 into a shape corresponding to the discharge spaces 18. In such a case, the first barrier ribs 16 and the rear substrate 10 are made of the same materials.

The first barrier ribs 16 include first barrier rib members 16a and second barrier rib members 16b. The first barrier rib members 16a extend along a first direction (y-axis direction in the drawings), and the second barrier rib members 16b extend along a second direction (x-axis direction in the drawings) intersecting the first direction. The first discharge spaces 18 are partitioned by the first barrier rib members 16a and the second barrier rib members 16b. However, the structure of the barrier ribs is not limited to the above-described structure. A stripe-type barrier rib structure including barrier rib members parallel only to the first direction may be applied to the present invention, and barrier rib structures of various shapes partitioning a second discharge space are possible and are also within the scope of the present invention.

First electrodes (hereinafter referred to as address electrodes) 22 extend along the first direction on the surface of the front substrate 20 facing the rear substrate 10. The address electrodes 22 are arranged parallel to and spaced apart from each other. A second dielectric layer (hereinafter referred to as front dielectric layer) 24 is formed on the front substrate 20 and covers the address electrodes 22. Second electrodes (hereinafter referred to as sustain electrodes) 25 and third electrodes (hereinafter referred to as scan electrodes) 26 are formed on the front dielectric layer 24 and extend along the second direction.

A third dielectric layer (hereinafter referred to as electrode dielectric layer) 28 is formed on the front dielectric layer 24 and covers the sustain electrodes 25 and the scan electrodes 26. The electrode dielectric layer 28 includes a first dielectric member 28a and a second dielectric member 28b. The first dielectric members 28a correspond to the first barrier rib members 16a and extend along the first direction. The second dielectric members 28b correspond to the second barrier rib members 16b and extend along the second direction crossing the first dielectric members 28a. A plurality of second discharge spaces 21 are partitioned by the first dielectric members 28a and the second dielectric members 28b that cross each other.

The first discharge spaces 18 are partitioned by the first barrier rib members 16a and the second barrier rib members 16b, and the second discharge spaces 21 are partitioned on the front substrate 20. The first and second discharge spaces 18 and 21 are formed in shapes corresponding to each other and substantially define each discharge cell 17.

A protective layer 27 may be formed on the outer surface of the front dielectric layer 24 and the electrode dielectric layer 28. It is preferable for the protective layer 27 to be formed on the outer surface of the dielectric layers that are exposed to the gas discharge. An example of the protective layer 27 may be a MgO protective layer 27. The MgO protective layer 27 protects dielectric layers against collision with ions that are dissociated during the gas discharge. The MgO protective layer 27 may improve the efficiency of discharge due to a high secondary electron emission factor when colliding with the ions.

First phosphor layers 19 and second phosphor layers 29 are formed within the discharge cells 17. More specifically, the first phosphor layers 19 are formed on the side of the first barrier ribs 16 and on the rear dielectric layer 14 that are formed on the rear substrate 10, and the second phosphor layers 29 are formed on the outer surface of the first dielectric members 28a. The first phosphor layers 19 and the second phosphor layers 29 may be made of a reflective phosphor. As described above, the present embodiment has address electrodes 22 formed on the front substrate 20, and the first and second phosphor layers 19 and 29 formed on the rear substrate and the first dielectric members 28a respectively, thus solving the problem of an uneven discharge firing voltage during address discharge due to different permittivities between red, green, and blue phosphor layers.

Because the address discharge occurs at the address electrodes 22 on the front substrate 20 and the scan electrodes 26 located between the front and the rear substrate 20 and 10, electrical charges do not accumulate on the phosphor layer 19 on the rear substrate 10 and the first dielectric members 28a where the scan electrodes 26 are not addressed during an address discharge. Therefore, the loss of phosphor due to the accumulated charges on the first and second phosphor layers 19 and 29 by ion sputtering may be prevented.

In addition, by forming the second phosphor layer 29 on the outer surface of the first dielectric members 28a where the sustain electrodes 25 and the scan electrodes 26 are not formed, the phosphor layer may be located closer to ultraviolet rays generated during a sustain discharge without disturbing a sustain discharge occurring between the sustain electrodes 25 and the scan electrodes 26. Therefore, visible light transformation efficiency is improved, the amount of visible light increased, and the brightness is dramatically improved.

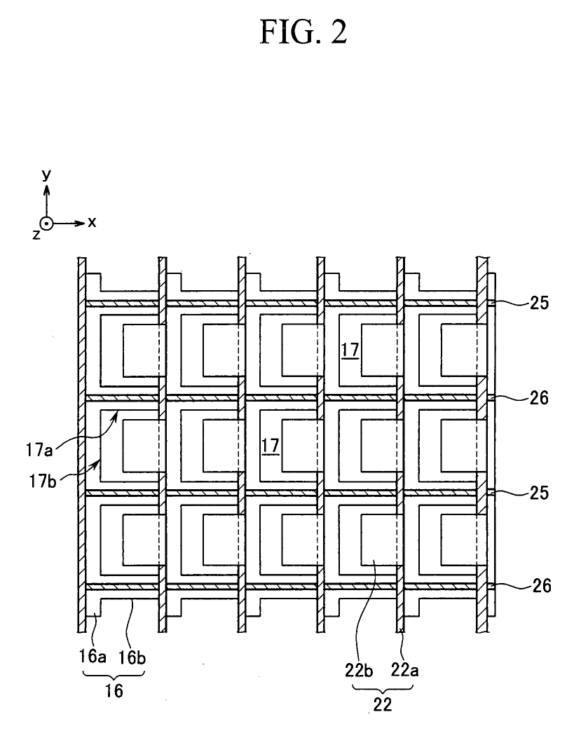

Referring to FIG. 2, the address electrodes 22 extend along a first direction (y-axis direction in the drawings) and include bus electrodes 22a and expansion electrodes 22b. The bus electrodes 22a correspond to the first barrier rib members 16a and extend along the first direction. The expansion electrodes 22b correspond to each discharge cell 17 and protrude from the bus electrodes 22a toward the center of each discharge cell 17.

In this case, the expansion electrodes 22b may be made of a transparent electrode material, for example ITO, for ensuring an adequate aperture ratio for the front substrate 20. Although the expansion electrodes are in the shape of a rectangle in the present embodiment, expansion electrodes of other shapes may also be applied to the present embodiment and are within the scope of the present invention. For example, expansion electrodes in a triangular shape gradually decreasing in size along a direction from the scan electrodes 26 toward the sustain electrodes 25 may be applied to the present embodiment, and a structure wherein the expansion electrodes 22b are arranged closer to the scan electrodes 26 than the sustain electrodes 25 may also be applied to the present embodiment. As above, the expansion electrodes 22b are formed in a larger size like the scan electrodes 26 or closer to the scan electrodes 26, and thus an address discharge between the expansion electrodes 22b and the scan electrodes 26 may occur easily.

The bus electrodes 22a may be made of a metal so as to ensure high conductivity by compensating for a high electrical resistance of the transparent electrodes. In the present embodiment, the bus electrodes 22a are located on the boundary of the discharge cells 17 adjacent to each other along the second direction (x-axis direction in the drawings). Thus, the present embodiment has the advantage that the aperture ratio for the front substrate 20 does not decrease even though the bus electrodes 22a are made of metal.

The sustain electrodes 25 and the scan electrodes 26 are formed along a direction intersecting the address electrodes 22. In the present embodiment, the address electrodes 25 and the scan electrodes 26 are located on the boundary of discharge cells 17 adjacent to each other along the first direction, and are arranged alternately along the first direction. The scan electrodes 26 enable an address discharge by interacting with the address electrodes 22 during an addressing period. The discharge cells 17 to be turned on are selected by the address discharge. The sustain electrodes 25 enable a sustain discharge by interacting mainly with the scan electrodes 26. Images are displayed through the front substrate 20 by the sustain discharge. However, the role of each electrode varies with the kind of voltage supplied to the electrode and is not limited to the above.

The sustain electrodes 25 and the scan electrodes 26 may also be formed of a metal. In other words, in the present embodiment, the sustain electrodes 25 and the scan electrodes 26 are located on the boundaries of discharge cells adjacent to each other along the first direction, so that the aperture ratio does not decrease, even if the electrodes are made of a metal.

Each discharge cell includes a first portion 17a and a second portion 17b. The sustain electrodes 25 and the scan electrodes 26 are arranged in the first portion 17a, but not in the second portion 17b. In addition, the phosphor layer formed in the second portion 17b is arranged closer to the space between the sustain electrodes 25 and the scan electrodes 26 than the phosphor layer formed in the first portion 17a. Therefore, the ultraviolet rays that are generated by a sustain discharge between the sustain electrodes 25 and the scan electrodes 26 interact more efficiently with the phosphor layer, thus improving the transformation efficiency and the visible light brightness. The above relationship between the sustain electrodes 25 and the scan electrodes 26 is described in detail later with regard to another drawing.

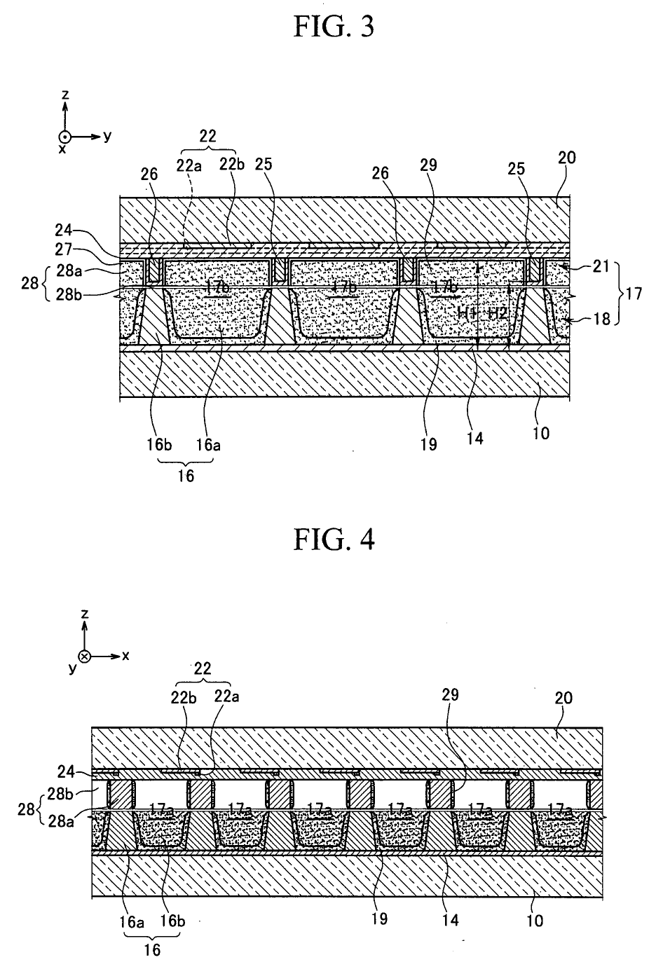

Referring to FIG. 3, the sustain electrodes 25 and the scan electrodes 26 are formed on the front dielectric layer 24 covering the address electrodes 22. The sustain electrodes 25 and the scan electrodes 26 protrude along a direction away from the front substrate 20, and face each other with a space therebetween. The cross-sections of the sustain electrodes 25 and the scan electrodes may be formed to have a dimension along a direction perpendicular to the substrates 10 and 20 (z-axis direction) greater than a dimension along a direction parallel to the substrates 10 and 20 (y-axis direction). In other words, the height of the sustain electrodes 25 and the scan electrodes 26 measured from the surface of the front substrate 20 may be greater than their widths in the y-axis direction. By increasing the height of the sustain electrodes 25 and the scan electrodes 25, even if the size of the discharge cell along a planar direction is be diminished, the decrement of size can be compensated for. Furthermore, by enlarging the surface of the sustain electrodes 25 and the scan electrodes 26 facing each other, the luminescence efficiency may be higher than that of the surface discharge PDP.

The electrode dielectric layer 28 is formed on the outer surface of the sustain electrodes 25 and the scan electrodes 26. The electrode dielectric layer 28 and the front dielectric layer 24 covering the address electrodes 22 may be made of the same material, thus protecting each electrode against collision with ions generated during a gas discharge. Wall charges may accumulate on the front dielectric layer 24 and the electrode dielectric layer 28, thus lowering the discharge firing voltage during a sustain discharge between the sustain electrodes 25 and the scan electrodes 26.

The second phosphor layer 29 is formed on the first dielectric members 28a of the front dielectric layer 28. Specifically, a height (H1) of the second phosphor layer 29 formed in the second portion 17b of the discharge cell 17, measured along a direction (z-axis direction in the drawings) perpendicular to the rear substrate 10, is greater than a distance (H2) from the rear substrate 10 to the sustain and scan electrodes 25 and 26. Therefore, the first phosphor layer 19 and the second phosphor layer 29 are respectively formed on the side of the first barrier rib members 16a and the first dielectric members 28a in the second portion 17b. As stated above, the second phosphor layer 29 is formed on the first dielectric members 28a, and thus phosphor layers are arranged closer to ultraviolet rays generated during a discharge between the sustain electrodes 25 and the scan electrodes 26. Therefore, the effective area of the phosphor layers reacting with ultraviolet rays may be dramatically increased, and the transformation efficiency and the visible light brightness may be further improved.

Referring to FIG. 4, in the first portion 17a of the discharge cell, the first phosphor layer 19 is formed on the side of the second barrier rib members 16b but the second phosphor layer 28b is not formed on the second dielectric members 28b. In other words, the second phosphor layer 29 is not formed on the second dielectric members 28b that substantially surround the sustain and scan electrodes, but is formed on the first dielectric members 28a. Due to the above structure, the second phosphor layer 29 does not significantly affect the discharge between sustain electrodes and scan electrodes opposing each other, and thus a stable sustain discharge may occur.

Although the front substrate 10 and the rear substrate 20 are depicted to be spaced apart, it is to be noted that they contact each other partially or altogether.

Descriptions follow of various embodiments of the present invention. The plasma display panel according to each embodiment has the same structure and function as that of the first embodiment, and accordingly, a detailed description thereof has been omitted.

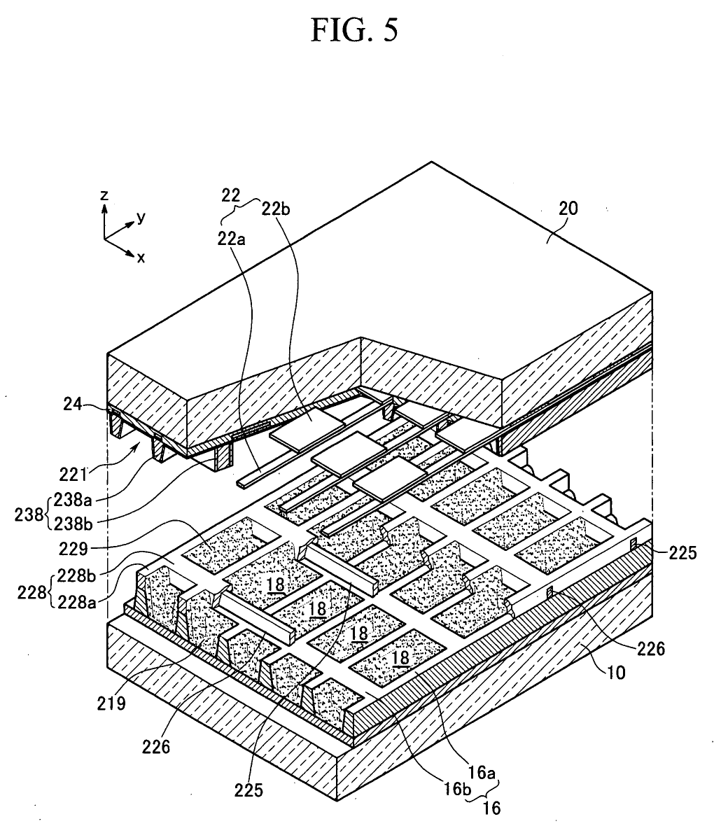

Referring to FIG. 5, second barrier ribs 238 are formed on the front substrate 20 in a shape corresponding to the first barrier ribs 16. The second barrier ribs 238 include third barrier rib members 238a that correspond to the first barrier rib members 16a and extend along the first direction, and fourth barrier rib members 238b that correspond to the second barrier rib members 16b and extend along the second direction. Second discharge spaces 221 that correspond to the first discharge spaces 18 are partitioned by the third barrier rib members 238a and the fourth barrier rib members 238b, and each discharge cell is defined by the first and the second discharge spaces 18 and 221.

In this embodiment, the sustain electrodes 225 and the scan electrodes 226 are manufactured separately and inserted between the front and rear substrate 10 and 20. Specifically, the sustain electrodes 225 and the scan electrodes 226 extend along a second direction (x-axis direction in the drawings) crossing the address electrodes 225 between the front substrate 10 and the rear substrate 20. That is, the sustain electrodes 225 and the scan electrodes 226 are arranged alternately in the first direction (y-axis direction in the drawings) on the boundary of discharge cells adjacent to each other along the first direction. As stated above, the sustain electrodes 225 and the scan electrodes 226 are manufactured separately, thus dramatically simplifying the process for manufacturing a PDP.

Electrode dielectric layers 228 are formed on the outer surface of the sustain electrodes 225 and the scan electrodes 226. The electrode dielectric layers 228 include first dielectric members 228a that correspond to the first barrier rib members 16a and the third barrier rib members 238a and extend along the first direction, and second dielectric members 228b that correspond to the second barrier rib members 16b and the fourth barrier rib members 238b and extend along the second direction.

A first phosphor layer 219 is formed on the surface of the first dielectric members 228a that does not substantially surround the sustain electrodes 225 and the scan electrodes 226. Specifically, the first phosphor layer 219 is formed on the side of the first barrier rib members 16a and the second barrier rib members 16b, and on the surface of the first dielectric members 228a of the electrode dielectric layer 228. As stated above, the phosphor layer 219 is formed on the first dielectric members 228a and arranged closer to spaces between the sustain electrodes 225 and the scan electrodes 226, thus further improving the efficiency in transformation of visible light.

In addition, a phosphor layer may be formed on the second barrier rib members 238 on the first substrate 20, and it is preferable for the phosphor layer to be made of a transparent phosphor.

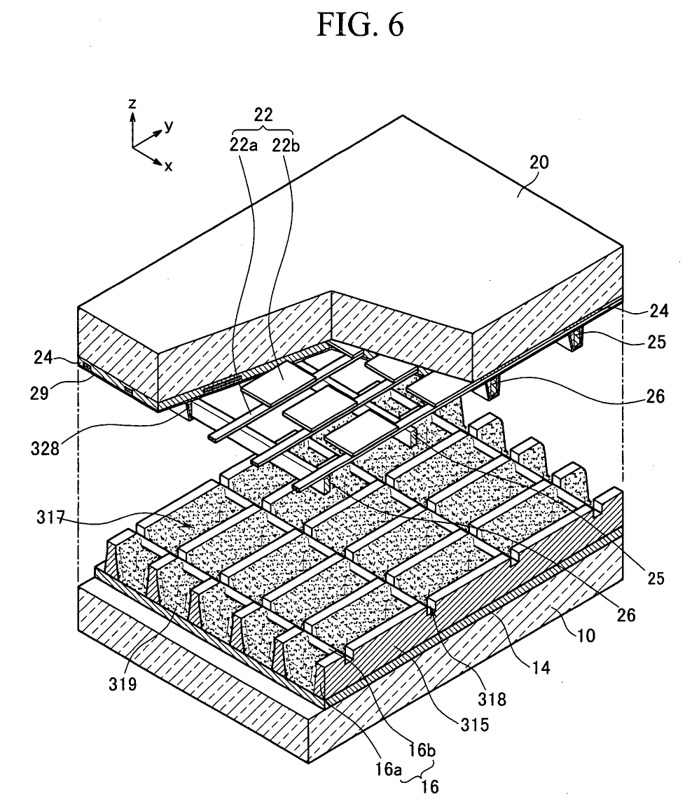

Referring to FIG. 6, expanded portions 315 are formed on the first barrier rib members 16a on the rear substrate 10 and extend from the first barrier rib members 16a along a direction (z-axis direction in the drawings) perpendicular to the rear substrate 10. The expanded portions 315 and the first barrier rib members 16a may be formed as a unit. The expanded portions 315 correspond to a width of each discharge cell 317 measured along the first direction, and extend along the first direction. Recessed portions 318 are formed between expanded portions 315 adjacent to each other along the first direction, and more specifically, the recessed portions 318 are located on the boundary of discharge cells 317 adjacent to each other along the first direction.

Although the address electrodes 22, the sustain electrodes 25, and the scan electrodes 26 have the same structures as those of the first embodiment, the electrode dielectric layer 328 formed on the surface of the sustain electrodes 25 and the scan electrodes 26 does not have a matrix-type structure, but rather has a striped structure extending along the second direction.

As stated above, the electrode dielectric layers 328 are formed on the sustain electrodes 25 and the scan electrodes 26 and extend along the second direction, and the recessed portions 318 are formed on the boundary of discharge cells 317 adjacent to each other on the rear substrate 10 along the first direction, and thus, the sustain electrodes 25 and the scan electrodes 26 can be fitted into the recessed portions 318 when the front substrate 10 and the rear substrate 20 are joined together. Therefore, a PDP that has a matrix-type discharge cell and generates an opposed discharge can be easily manufactured.

In addition, in the present embodiment, the first phosphor layers 319 are formed on the expanded portions 315 adjacent to each other with discharge cells therebetween, and thus, the phosphor layers 319 are located close to spaces between the sustain electrodes 25 and the scan electrodes 26 when the front substrate 10 and the rear substrate 20 are joined together. Therefore, the effective area wherein the phosphor layers react with ultraviolet rays is increased, and the transformation efficiency and the brightness of visible light is further improved.

Although certain exemplary embodiments of the present invention have been shown and described, the present invention is not limited to the described embodiments, but may be modified in various forms without departing from the scope of the invention set forth in the detailed description, the accompanying drawings, and the appended claims.

What is claimed is:

1. A plasma display panel (PDP) comprising:
a first substrate;
a second substrate facing the first substrate;
discharge cells partitioned between the first substrate and the second substrate;
first electrodes extending in a first direction between the first substrate and the second substrate;
second electrodes extending in a second direction crossing the first direction between the first substrate and the second substrate, and protruding in a direction away from the second substrate;
third electrodes extending in the second direction between the first substrate and the second substrate, and protruding in a direction away from the second substrate; and
phosphor layers arranged within the discharge cells, the discharge cells including:
a first portion having the second electrodes and the third electrodes arranged therein; and
a second portion devoid of second electrodes and third electrodes therein; and
wherein a phosphor layer arranged within the second portion has a height, measured in a direction perpendicular to the first substrate, greater than a distance between the first substrate and the second and third electrodes.

2. The PDP of claim 1, further comprising barrier ribs partitioning the discharge cells and arranged adjacent to the first substrate, the barrier ribs including:
first barrier rib members extending along the first direction; and
second barrier rib members extending along the second direction.

3. The PDP of claim 2, further comprising second barrier ribs partitioning the discharge cells and arranged adjacent to the second substrate, the second barrier ribs including:
third barrier rib members extending along the first direction; and
fourth barrier rib members extending along the second direction.

4. The PDP of claim 3, wherein the first barrier rib members and the second barrier rib members define a first discharge space;
wherein the third barrier rib members and the fourth barrier rib members define a second discharge space facing the first discharge space; and
wherein the first discharge space and the second discharge space define each discharge cell.

5. The PDP of claim 2, wherein electrode dielectric layers are arranged on outer surfaces of the second electrodes and the third electrodes, the electrode dielectric layers including:
first dielectric members extending along the first direction; and
second dielectric members crossing the first dielectric members and extending along the second direction.

6. The PDP of claim 5, wherein the first dielectric members are arranged to correspond to the first barrier rib members; and
wherein the phosphor layers are arranged on sides of the first dielectric members and the first barrier rib members.

7. The PDP of claim 1, wherein the second electrodes and the third electrodes are arranged on boundaries of discharge cells adjacent to each other along the first direction, and are arranged alternately along the first direction.

8. The PDP of claim 1, wherein the first electrodes are arranged on boundaries of discharge cells adjacent to each other along the second direction on the second substrate, and include expansion electrodes protruding into centers of respective discharge cells.

9. The PDP of claim 8, wherein the expansion electrodes are arranged closer to the third electrodes than the second electrodes.

10. A plasma display panel (PDP) comprising:
a first substrate;
a second substrate facing the first substrate;
barrier ribs partitioning a plurality of discharge cells between the first substrate and the second substrate, and including first barrier rib members extending in a first direction;
first electrodes extending in the first direction between the first substrate and the second substrate;
second electrodes extending in a second direction crossing the first direction between the first substrate and the second substrate, and protruding in a direction away from the second substrate;
third electrodes extending in the second direction and protruding in a direction away from the second substrate;
expanded portions arranged to correspond to respective discharge cells and extending from the first barrier rib members in a direction perpendicular to the first substrate; and
phosphor layers arranged on the expanded portions.

11. The PDP of claim 10, wherein the expanded portions and the first barrier rib members have a unitary structure.

12. The PDP of claim 10, wherein recessed portions are arranged between expanded portions adjacent to each other along the first direction, the recessed portions being arranged on boundaries of discharge cells adjacent to each other along the first direction.

13. The PDP of claim 12, wherein the second electrodes and the third electrodes are arranged in the recessed portions, and wherein a height of the phosphor layers, measured along a direction perpendicular to the first substrate, is greater than a distance between the first substrate and the second and third electrodes.
